(19) United States
(12) Patent Application Publication
(10) Pub. No.: US 2020/0106471 A1
(43) Pub. Date: Apr. 2, 2020

(54) TRANSMITTING AND RECEIVING SWITCH, TRANSMITTING AND RECEIVING APPARTUS, AND OPERATING METHOD OF TRANSMITTING AND RECEIVING SWITCH

(71) Applicant: ELECTRONICS AND TELECOMMUNICATIONS RESEARCH INSTITUTE, Daejeon (KR)

(72) Inventors: Seunghyun JANG, Daejeon (KR); Sunwoo KONG, Daejeon (KR); Kwang Seon KIM, Sejong (KR); Jeehoon PARK, Daejeon (KR); Hui Dong LEE, Daejeon (KR); Kwangchun LEE, Daejeon (KR)

(21) Appl. No.: 16/573,928

(22) Filed: Sep. 17, 2019

(30) Foreign Application Priority Data
Oct. 1, 2018 (KR) 10-2018-0117214

(51) Int. Cl. H04B 1/44; H04B 1/525

(52) U.S. Cl. CPC H04B 1/44; H04B 1/525

(57) ABSTRACT

A transmitting and receiving switch, a transmitting and receiving apparatus, and an operating method of a transmitting and receiving switch are disclosed.

The transmitting and receiving switch may include a first switch configured to be connected between the transmitting front-end module and the antenna, a second switch configured to be connected between the receiving front-end module and a ground, and a first inductor configured to be connected between the second switch and the antenna, a second inductor configured to be connected between the antenna and the ground, and a variable capacitor configured to be connected between the antenna and the ground.

### CROSS-REFERENCE TO RELATED APPLICATION

This application claims priority to and the benefit of Korean Patent Application No. 10-2018-0117214 filed in the Korean Intellectual Property Office on Oct. 1, 2018, the entire contents of which are incorporated herein by reference.

### BACKGROUND OF THE INVENTION

### (a) Field of the Invention

The present invention relates to a transmitting and receiving switch, a transmitting and receiving apparatus, and an operating method of a transmitting and receiving switch.

### (b) Description of the Related Art

The International Telecommunications Union Radiocommunication Sector (ITU-R), an international standardization organization, is currently working on the IMT-2020 development process to announce the first recommendations of the 5G mobile communication system in 2020. The IMT-2020 aims at a maximum transmission rate of 20 Gbps, a user experience transmission speed of at least 100 Mbps, a transmission latency of less than 1 ms, and an energy efficiency improvement of about 100 times that of the 4G mobile communication system. This 5G mobile communication system is expected to provide immersive communication, ultra-real time service, augmented reality, internet of things, and big data-based service. However, a conventional mobile communication system using a frequency band below 6 GHz has a limit in that the available signal bandwidth for the transmission rate defined by IMT-2020 is not wide. Therefore, the 5G mobile communication technology using a millimeter wave frequency band securing a wider frequency band is being actively developed worldwide.

A wireless mobile communication system needs to amplify a signal with sufficiently large power at a base station and a terminal and then transmit it in order to provide wider communication coverage and faster transmission speed to the subscriber.

In a wireless mobile communication system, a transmitting and receiving apparatus (i.e., a base station or a terminal) includes a front-end module for transmitting and receiving radio signals. In general, the front-end module includes a transmitting front-end module, a transmitting and receiving switch, and a receiving front-end module. The transmitting front-end module amplifies the power of communication signal to output high transmission power, and then transmits it to the transmitting and receiving switch. The transmitting and receiving switch transfers the signal to the antenna terminal after receiving the output signal of the transmitting front-end module, and prevents the signal from being transmitted to the receiving front-end module. The transmitting and receiving switch needs a high-power design so that it can handle the high-power signal of the transmitting front-end module.

Meanwhile, the transmitting and receiving switch requires an anti-static circuit. Electrostatic discharge (ESD) is the transfer of charge between objects with different potentials. An impulse-shaped voltage and current generated during the electrostatic discharge damage an electronic circuit or cause malfunction of the electronic circuit. Particularly, due to the recent miniaturization of the semiconductor process, the size of the transistor is reduced, so that the electronic circuit is more sensitive to the electrostatic discharge. Accordingly, the transmitting and receiving switch need to transmit a high output signal and requires an anti-static circuit.

However, in a high frequency band (for example, a millimeter wave frequency band) expected to be used in the next generation mobile communication, a capacitor having very small capacitance has high impedance. Accordingly, it is not easy to apply a general anti-static circuit composed of diodes. Recently, an anti-static circuit using an inductor rather than a diode has been studied. Adding an inductor to prevent static electricity has the following disadvantages. If an inductor is additionally connected to the transmitting and receiving switch, an insertion loss of a signal becomes larger, and the transmission power efficiency of the transmitting apparatus may deteriorate due to the increased insertion loss. The added anti-static inductors result in a larger chip size, which increases chip fabrication costs.

### SUMMARY OF THE INVENTION

The present invention provides a transmitting and receiving switch, a transmitting and receiving apparatus, and an operating method of a transmitting and receiving switch operating on a high output signal.

The present invention provides a transmitting and receiving switch, a transmitting and receiving apparatus, and an operating method of a transmitting and receiving switch in which an inductor used for impedance matching can simultaneously perform an anti-static function.

According to an exemplary embodiment of the present invention, a transmitting and receiving switch for transmitting a transmission signal received from a transmitting front-end module to an antenna and for transmitting a reception signal received from the antenna to a receiving front-end module is provided. The transmitting and receiving switch may include a first switch configured to be connected between the transmitting front-end module and the antenna, a second switch configured to be connected between the receiving front-end module and a ground, a first inductor configured to be connected between the second switch and the antenna, a second inductor configured to be connected between the antenna and the ground, and a variable capacitor configured to be connected between the antenna and the ground.

When the transmitting and receiving switch operates in a transmission mode, the first switch and the second switch may be turned on.

When the transmitting and receiving switch operates in a reception mode, the first switch and the second switch may be turned off.

The variable capacitor may be set to a higher capacitance value when the transmitting and receiving switch operates in a transmission mode than when the transmitting and receiving switch operates in a reception mode.

The first inductor, the second inductor, and the variable capacitor may perform an impedance matching function. The second inductor may perform an anti-static circuit function together with the impedance matching function.

Static electricity applied to the antenna may flow through the second inductor and the ground.

The variable capacitor may include a first capacitor configured to be connected between the antenna and the ground, a second capacitor configured to have one end connected to the antenna, and a third switch configured to be connected between the other end of the second capacitor and the ground.

When the transmitting and receiving switch operates in a transmission mode, the third switch may be turned on, and when the transmitting and receiving switch operates in a reception mode, the third switch may be turned off.

Each of the first switch and the second switch may be a transistor, a gate resistor may be connected to a gate of each of the transistors, and a body resistor may be connected to a body terminal of each of the transistors.

When the transmitting and receiving switch operates in a transmission mode, the transmission signal may be applied to both ends of the first inductor.

According to another exemplary embodiment of the present invention, a transmitting and receiving apparatus is provided. The transmitting and receiving apparatus may include a transmitting front-end module configured to output a transmission signal, a receiving front-end module configured to receive a reception signal from the antenna, a first switch configured to be connected between the antenna and the transmitting front-end module and turned on at the time of transmission of the transmission signal, a second switch configured to be connected between the receiving front-end module and a ground and turned on at the time of transmission of the transmission signal, a first inductor configured to be connected between the second switch and the antenna, a second inductor configured to be connected between the antenna and the ground, and a variable capacitor configured to be connected in parallel to the second inductor. The first switch and the second switch may be turned off at the time of reception of the reception signal.

The variable capacitor may have a higher capacitance value at the time of reception of the reception signal than at the time of transmission of the transmission signal.

The second inductor may perform an anti-static circuit function together with an impedance matching function.

When the second inductor performs the anti-static circuit function, static electricity applied to the antenna may flow through the second inductor and the ground.

The variable capacitor may include a first capacitor configured to be connected between the antenna and the ground, a second capacitor configured to have one end connected to the antenna, and a third switch configured to be connected between the other end of the second capacitor and the ground.

When the transmitting and receiving apparatus operates in a transmission mode, the third switch may be turned on, and when the transmitting and receiving apparatus operates in a reception mode, the third switch may be turned off.

According to another exemplary embodiment of the present invention, an operating method of a transmitting and receiving switch for transmitting a transmission signal received from a transmitting front-end module to an antenna and for transmitting a reception signal received from the antenna to a receiving front-end module is provided. The operating method may include transmitting a transmission signal to the antenna by turning on a first switch connected between the transmitting front-end module and the antenna and turning on a second switch connected between the receiving front-end module and the ground in a transmission mode, and providing impedance matching by using a first inductor connected between the second switch and the antenna, a second inductor connected between the antenna and the ground, and a variable capacitor connected between the antenna and the ground in the transmission mode.

The method may further include transmitting the reception signal to the receiving front-end module by turning off the first switch and the second switch in a reception mode, and providing impedance matching by using the first inductor, the second inductor, and the variable capacitor.

The capacitance value of the variable capacitor may be set to a higher value in the transmission mode than in the reception mode.

According to the exemplary embodiment of the present invention, since most of the high output signal is applied to both ends of the passive element during the transmission mode operation of the transmitting and receiving switch, a stable switching function may be provided at a high transmission signal output.

According to the exemplary embodiment of the present invention, since some of the internal matching circuits of the transmitting and receiving switch operate as an anti-static circuit, no additional anti-static circuit may be required.

### BRIEF DESCRIPTION OF THE DRAWINGS

FIG. 1 is a diagram showing a transmitting and receiving apparatus according to an exemplary embodiment of the present invention

FIG. 2A is a diagram showing an equivalent circuit in the transmission mode operation of the transmitting and receiving switch according to the exemplary embodiment of the present invention, and FIG. 2B is a diagram showing a Smith chart for impedance matching of FIG. 2A.

FIG. 3A is a diagram showing an equivalent circuit in the reception mode operation of the transmitting and receiving switch according to the exemplary embodiment of the present invention, and FIG. 3B is a diagram showing a Smith chart for impedance matching of FIG. 3A.

FIG. 4 is a diagram showing a case where the first switch and the second switch of FIG. 1 are implemented as transistors.

FIG. 5 is a diagram showing a case where a body resistor is connected to the first transistor and the second transistor, respectively, in FIG. 4.

FIG. 6 is a diagram showing an internal configuration of the variable capacitor of FIG. 1.

FIG. 7 is a diagram showing a case where the third switch of FIG. 6 is implemented by a transistor.

FIG. 8 is a diagram showing a case where a gate resistor and a body resistor are connected to the third transistor of FIG. 7.

FIG. 9 is a diagram showing a case where FIG. 5 and FIG. 8 are merged.

FIG. 10 is a graph showing a simulation result of a frequency characteristic in a transmission mode operation of the transmitting and receiving switch according to the exemplary embodiment of the present invention.

FIG. 11 is a graph showing results of a P1 dB simulation in the transmission mode operation of the transmitting and receiving switch according to the exemplary embodiment of the present invention.

FIG. 12 is a graph showing a simulation result of a frequency characteristic in a reception mode operation of the transmitting and receiving according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification, a transmitting and receiving apparatus may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), an user equipment (UE), or the like, and may include all or some of the functions of the terminal, the MT, the MS, the AMS, the HR-MS, the SS, the PSS, the AT, UE, or the like.

In addition, a transmitting and receiving apparatus may indicate a base station (BS), an advanced base station (ABS), a high reliability base station (HR-BS), a NodeB, an evolved NodeB (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like, and may include all or some of the functions of the BS, the ABS, the HR-BS, the NodeB, the eNodeB, the AP, the RAS, the BTS, the MMR-BS, the RS, the HR-RS, and the like.

Throughout this specification and the claims that follow, when it is described that an element is “coupled” to another element, the element may be “directly coupled” to the other element or “electrically coupled” to the other element through a third element. When it is described that an element is “connected” to another element, the element may be “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements. Unless explicitly described to the contrary, the word “include” and variations such as “includes” or “including”, will be understood to imply the inclusion of stated elements but not the exclusion of any other elements.

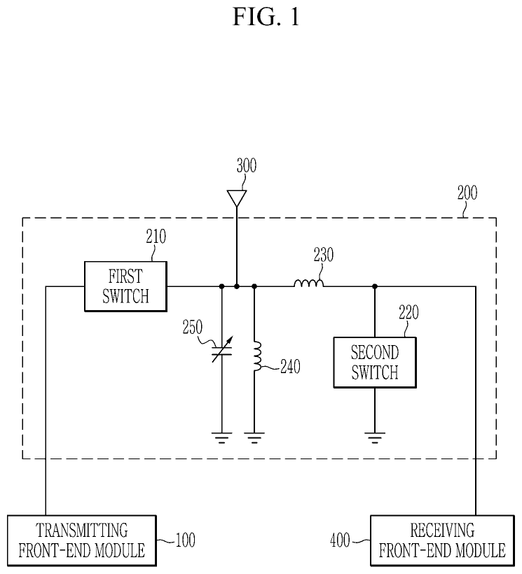

FIG. 1 is a diagram showing a transmitting and receiving apparatus 1000 according to an exemplary embodiment of the present invention.

As shown in FIG. 1, the transmitting and receiving apparatus 1000 according to an exemplary embodiment of the present invention includes a transmitting front-end module 100, a transmitting and receiving switch 200, an antenna 300, and a receiving front-end module 400.

The transmitting front-end module 100 generates a transmission signal and amplifies the power of the transmission signal. The transmission signal amplified in the transmitting front-end module 100 is transmitted to the transmitting and receiving switch 200. The transmitting front-end module 100 may include an oscillator, a filter, a power amplifier, and the like.

The transmitting and receiving switch 200 transmits a transmission signal received from the transmitting front-end module 100 to the antenna 300. Here, the transmitting and receiving switch 200 prevents the transmission signal from being transmitted to the receiving front-end module 400. The transmitting and receiving switch 200 transmits a reception signal received from the antenna 300 to the receiving front-end module 400. Here, the transmitting and receiving switch 200 prevents the reception signal from being transmitted to the transmitting front-end module 100. The transmitting and receiving switch 200 according to the exemplary embodiment of the present invention performs impedance matching as well as an anti-static circuit function, which will be described in detail below.

The antenna 300 transmits a transmission signal transmitted from the transmitting and receiving switch 200 and transmits a reception signal received from the outside to the transmitting and receiving switch 200. The antenna 300 may be implemented as a transmitting and receiving antenna that simultaneously performs transmission and reception, and a transmitting antenna or a receiving antenna may be separately implemented.

The receiving front-end module 400 amplifies and demodulates the reception signal transmitted from the transmitting and receiving switch 200. The receiving front-end module 400 may include a low noise amplifier (LNA), a filter, an oscillator, and the like.

As shown in FIG. 1, the transmitting and receiving switch 200 according to the exemplary embodiment of the present invention includes a first switch 210, a second switch 220, a first inductor 230, a second inductor 240, and a variable capacitor 250.

The first switch 210 is connected between the transmitting front-end module 100 and the antenna 300 to perform a switching function. The second switch 220 is connected between the receiving front-end module 400 and the ground to perform a switching function. When the transmitting and receiving apparatus 1000 operates in a transmission mode, the first switch 210 and the second switch 220 are turned on. When the transmitting and receiving apparatus 1000 operates in a reception mode, the first switch 210 and the second switch 220 are turned off.

The first inductor 230 is connected between the second switch 220 and the antenna 300 to perform an impedance matching function.

The second inductor 240 is connected between the antenna 300 and the ground to perform an impedance matching function as well as an anti-static circuit function.

The variable capacitor 250 is connected between the antenna 300 and the ground and connected in parallel with the second inductor 240, and a capacitance value of the variable capacitor 250 is adjusted by an external control signal. The variable capacitor 250 performs an impedance matching function. As described below, the variable capacitor 250 according to the exemplary embodiment of the present invention is set to a higher capacitance value in the transmission mode operation than in the reception mode operation.

The ground shown in FIG. 1 may be a direct current (DC) ground or an alternating ground (AC) ground.

The operation of the transmitting and receiving switch 200 will be described below.

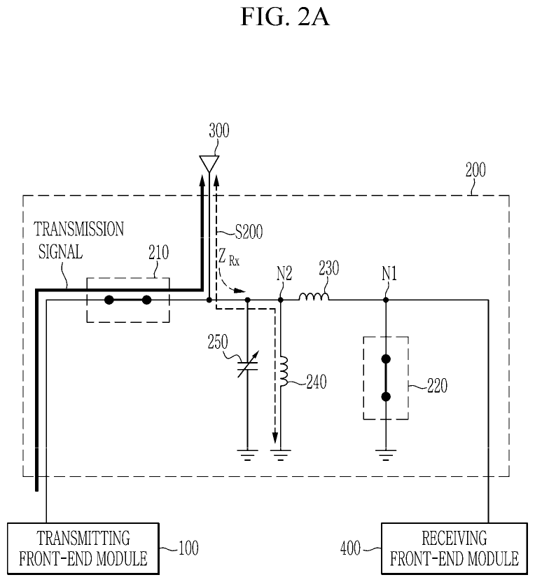

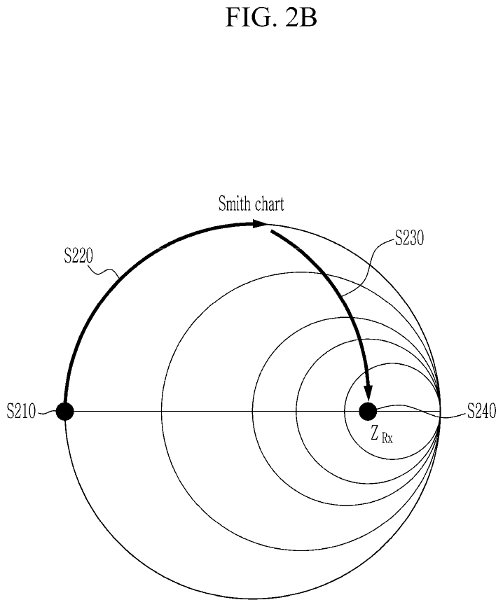

First, a case where the transmitting and receiving apparatus 1000 operates in a transmission mode, that is, a case where the transmitting and receiving switch 200 operates in a transmission mode, will be described with reference to FIGS. 2A and 2B.

FIG. 2A is a diagram showing an equivalent circuit in the transmission mode operation of the transmitting and receiving switch 200 according to the exemplary embodiment of the present invention, and FIG. 2B is a diagram showing a Smith chart for impedance matching of FIG. 2A.

During the transmission mode operation of the transmitting and receiving switch 200, the first switch 210 is turned on and the output signal of the transmitting front-end module 100 is transmitted to the antenna 300. During the transmission mode operation of the transmitting and receiving switch 200, the second switch 220 is also turned on, thereby connecting one end of the first inductor 230 to the ground.

It is more advantageous for the impedance Z_{RX} seen from the antenna 300 to the receiving front-end module 400 to become as large as possible in order to minimize an insertion loss of the transmission signal transmitted to the antenna 300 through the first switch 210. Impedance (Z_{RX}) matching for achieving this effect will be described with reference to FIG. 2B.

Referring to FIG. 2B, since an input node N1 of the receiving front-end module 400 is connected to the ground due to the second switch 220, the impedance at the input node N1 of the receiving front-end module 400 becomes very low. Accordingly, the impedance is indicated at a point S210 corresponding to a short on the Smith chart. Further, the impedance at the node N2 moves along a path S220 on the Smith chart due to the first inductor 230. Finally, due to the second inductor 240 and the variable capacitor 250 connected in parallel to each other, the impedance Z_{RX} moves along a path S230 on the Smith chart and reaches a high impedance point 3240. Here, in order for the inductive property of the second inductor 240 to be canceled and the impedance Z_{RX} to move along the path S230 on the Smith chart, the variable capacitor 250 is controlled to have a large capacitance value. In the transmission mode of the transmitting and receiving switch 200, the capacitance value of the variable capacitor 250 may be determined in consideration of the impedances of the other circuits constituting the impedance matching.

Meanwhile, the impedance point and the impedance conversion path on the Smith chart shown in FIG. 2B may vary depending on components such as parasitic resistance, parasitic inductance, and parasitic capacitance considered in actual implementation of the transmitting and receiving switch 200, and the actual impedance of the antenna 300, the transmitting front-end module 100, and the receiving front-end module 400.

During the transmission mode operation of the transmitting and receiving switch 200, the high output signal of the transmitting front-end module 100 is transmitted to the antenna 300 through the first switch 210. At this time, most of the high output signal of the transmitting front-end module 100 is caught at both ends of the first inductor 230, and the signal applied to the second switch 220 and the receiving front-end module 400 becomes very small. As a result, a high output signal of the transmitting front-end module 100 can be transmitted in the transmission mode. In other words, the transmitting and receiving switch 200 according to the exemplary embodiment of the present invention is such that most of the high output signal is applied to both ends of the passive element (for example, the first inductor 230) in the transmission mode operation. Accordingly, the transmitting and receiving switch 200 can provide a stable switching function even at a high transmission signal output.

Referring to FIG. 2A, static electricity applied to the antenna 300 flows through a path S200 formed by the second inductor 240, thereby protecting other circuits. That is, even if an additional inductor is not used as an anti-static circuit of the transmitting and receiving switch 200, the second inductor 240 used for impedance matching in the transmitting and receiving switch 200 is used as an antistatic function. This eliminates the need for additional anti-static inductors or circuitry.

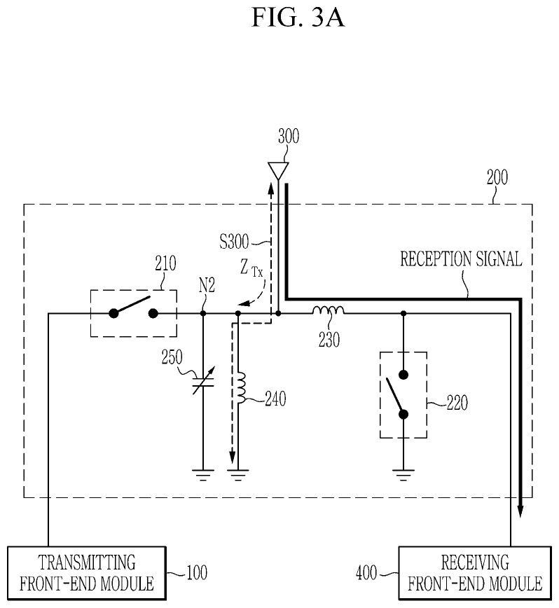

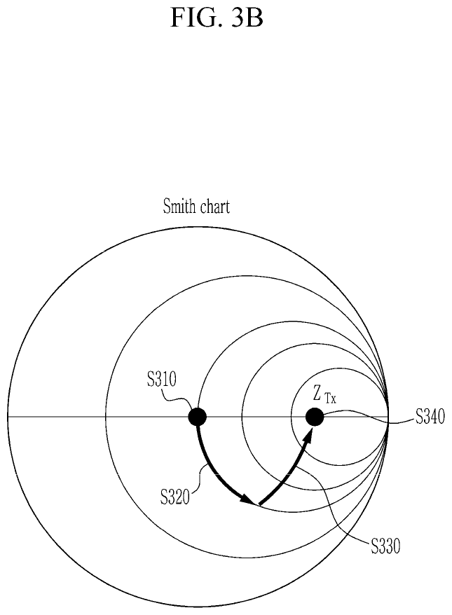

Next, a case where the transmitting and receiving apparatus 1000 operates in the reception mode, that is, the case where the transmitting and receiving switch 200 operates in the reception mode, will be described with reference to FIGS. 3A and 3B.

FIG. 3A is a diagram showing an equivalent circuit in the reception mode operation of the transmitting and receiving switch 200 according to the exemplary embodiment of the present invention, and FIG. 3B is a diagram showing a Smith chart for impedance matching of FIG. 3A.

During the reception mode operation of the transmitting and receiving switch 200, the first switch 210 is turned off, and the reception signal received from the antenna 300 is not transmitted to the transmitting front-end module 100. During the reception mode operation of the transmitting and receiving switch 200, the second switch 220 is also turned off, and the reception signal received from the antenna 300 is transmitted to the receiving front-end module 400.

It is more advantageous for the impedance Z_{TX} seen from the antenna 300 to the transmitting front-end module 400 to become as large as possible in order to minimize an insertion loss of the reception signal received from the antenna 300. Impedance (Z_{TX}) matching for achieving this effect will be described with reference to FIG. 3B.

Referring to FIG. 3B, assuming that the output impedance of the transmitting front-end module 100 is matched to 50 ohms, the impedance is indicated on the Smith chart at a 50 ohm point S310. Then, a parasitic capacitor generated at both ends of the first switch 210 cause the first switch 210 to look like a series capacitor, so that the impedance of the node N3 moves along a path S320 on the Smith chart. Finally, due to the second inductor 240 and the variable capacitor 250 connected in parallel to each other, the impedance Z_{TX} moves along a path S330 on the Smith chart and reaches a high impedance point S340. Here, since a inductive characteristic of the second inductor 240 needs to be large, the variable capacitor 250 is controlled to have a small capacitance value. In the reception mode of the transmitting and receiving switch 200, the capacitance value of the variable capacitor 250 may be determined in consideration of the impedances of the other circuits constituting the impedance matching.

Meanwhile, the impedance point and the impedance conversion path on the Smith chart shown in FIG. 3B may vary depending on components such as parasitic resistance, parasitic inductance, and parasitic capacitance considered in actual implementation of the transmitting and receiving switch 200, and the actual impedance of the antenna 300, the transmitting front-end module 100, and the receiving front-end module 400.

Referring to FIG. 3A, static electricity applied to the antenna 300 flows through a path S300 formed by the second inductor 240, thereby protecting other circuits. That is, even if an additional inductor is not used as an anti-static circuit of the transmitting and receiving switch 200, the second inductor 240 used for impedance matching in the transmitting and receiving switch 200 has an antistatic function. This eliminates the need for additional anti-static inductors or circuitry.

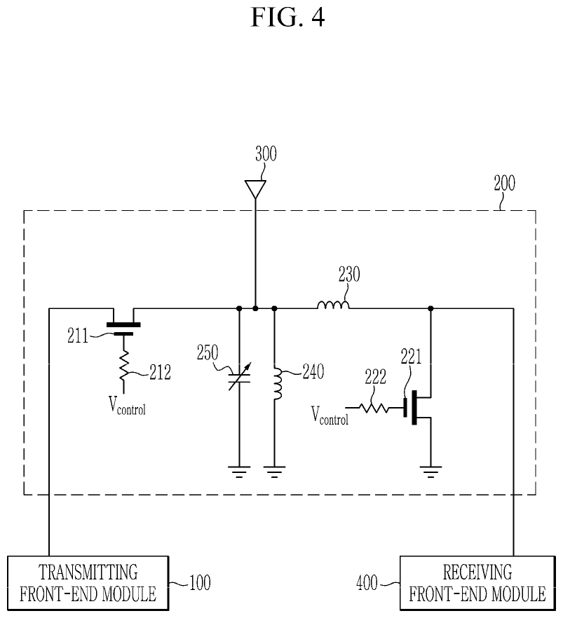

FIG. 4 is a diagram showing a case where the first switch 210 and the second switch 220 of FIG. 1 are implemented as transistors.

As shown in FIG. 4, the first switch 210 may be implemented as a first transistor 211 that is turned on or off by an external control signal. The second switch 220 may be implemented as a second transistor 221 that is turned on or off by an external control signal.

Each of the first transistor 211 and the second transistor 221 may be a metal oxide semiconductor (MOS) device using a deep N-well process.

A first gate resistor 212 is connected to a gate of the first transistor 211, and an external control signal V_{control} may be applied through the first gate resistor 212. A second gate resistor 222 is connected to a gate of the first transistor 211, and an external control signal V_{control} may be applied through the second gate resistor 222.

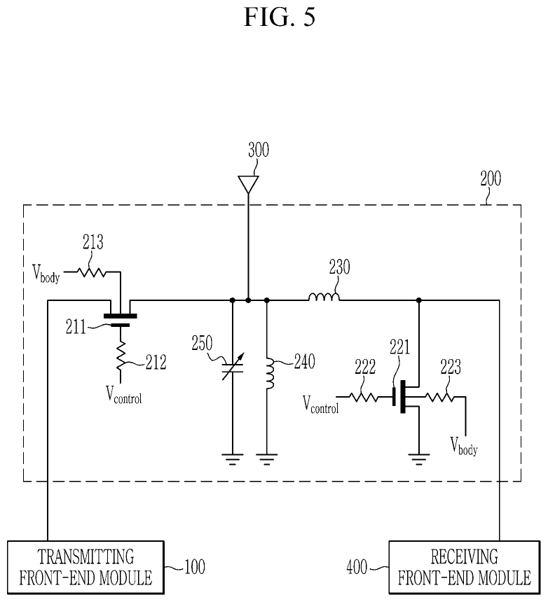

FIG. 5 is a diagram showing a case where a body resistor is connected to the first transistor 211 and the second transistor 221, respectively, in FIG. 4.

In order to reduce the influence of the parasitic capacitors associated with the body terminal of the first transistor 211 and the body terminal of the second transistor 221, a body floating technique may be applied. In order to apply the body floating technique, the first body resistor 213 is connected to a body terminal of the first transistor 211, and a second body resistor 223 is connected to a body terminal of the second transistor 221.

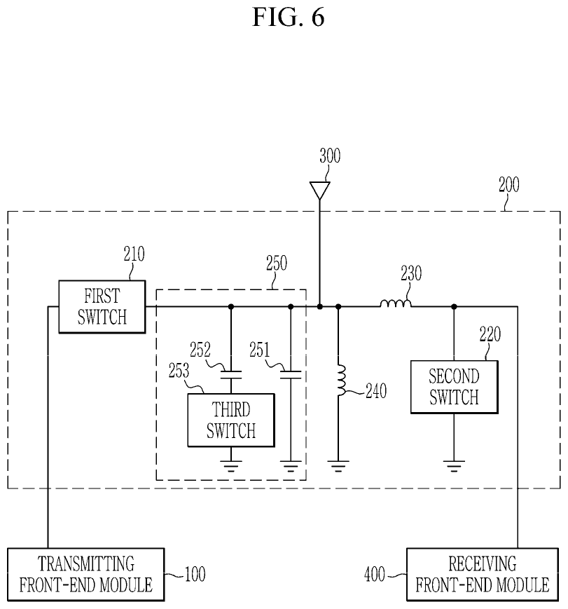

FIG. 6 is a diagram showing an internal configuration of the variable capacitor 250 of FIG. 1.

As shown in FIG. 6, the variable capacitor 250 according to the exemplary embodiment of the present invention includes a first capacitor 251, a second capacitor 252, and a third switch 253.

The first capacitor 251 is connected between the antenna 300 and the ground. One end of the second capacitor 252 is connected to the antenna 300, and the third switch 253 is connected between the other end of the second capacitor 252 and the ground.

When the transmitting and receiving switch 200 operates in the transmission mode, the third switch 253 is turned on, and the capacitance value of the variable capacitor 250 is increased. As a result, the impedance Z_{RX} increases as described in FIGS. 2A and 2B, and the insertion loss of the transmitting and receiving switch 200 decreases.

Meanwhile, when the transmitting and receiving switch 200 operates in the reception mode, the third switch 253 is turned off, and the capacitance value of the variable capacitor 250 is reduced. As a result, the impedance Z_{TX} is increased as described with reference to FIGS. 3A and 3B, and the insertion loss of the transmitting and receiving switch 200 is reduced.

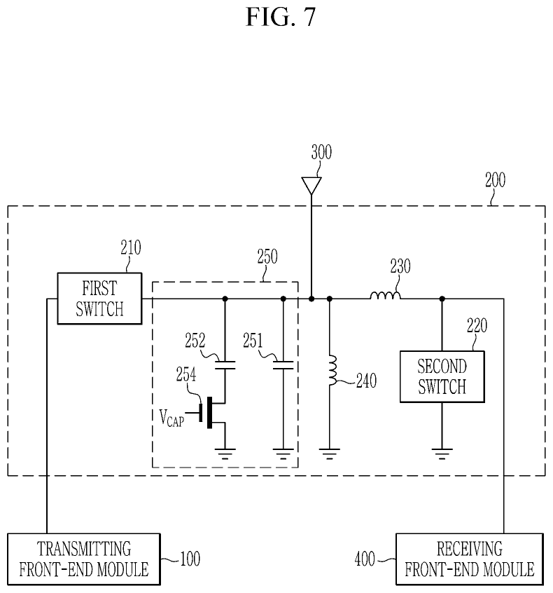

FIG. 7 is a diagram showing a case where the third switch 253 of FIG. 6 is implemented by a transistor.

As shown in FIG. 7, the third switch 253 may be implemented as a third transistor 254 which is turned on or off by an external control signal. The third transistor 254 may be a metal oxide semiconductor (MOS) device using a deep N-well process.

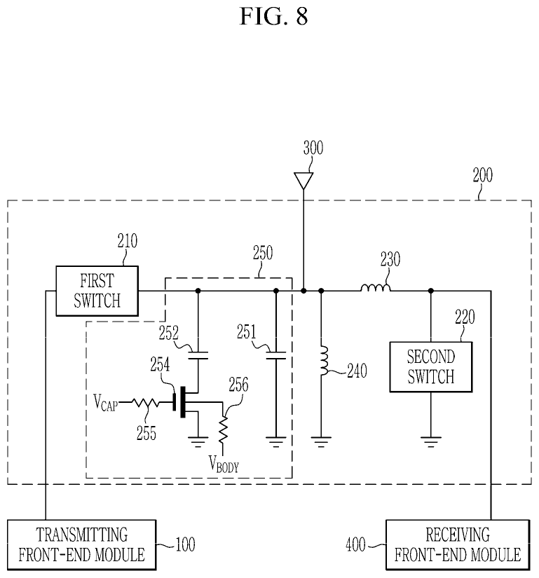

FIG. 8 is a diagram showing a case where a gate resistor and a body resistor are connected to the third transistor 254 of FIG. 7.

As shown in FIG. 8, a third gate resistor 255 may be connected to the gate of the third transistor 254, and an external control signal V_{CAP} may be applied through the third gate resistor 255.

In order to reduce the influence of the parasitic capacitors associated with the body terminal of the third transistor 254, a body floating technique may be applied. In order to apply the body floating technique, a third body resistor 256 is connected to a body terminal of the third transistor 254.

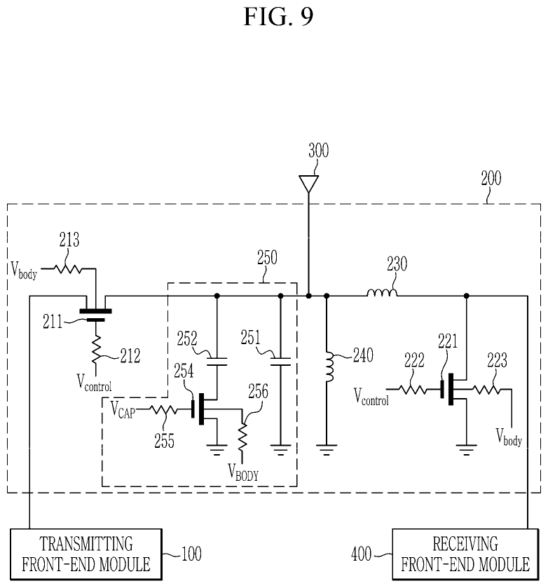

FIG. 9 is a diagram showing a case where FIG. 5 and FIG. 8 are merged. As shown in FIG. 9, the first to third switches 210, 220, and 253 may be implemented by transistors. A gate resistor and a body resistor may be connected to the first through third transistors 211, 221, and 254, respectively.

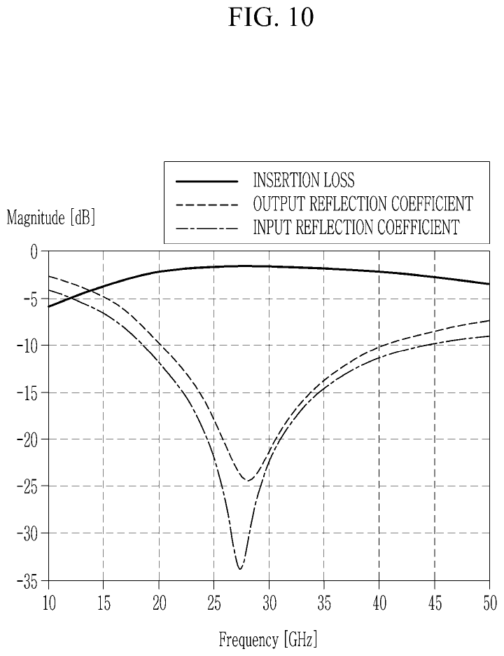

Hereinafter, simulation results for a case where the exemplary embodiment of the present invention is applied will be described with reference to FIGS. 10 to 12. FIGS. 10 to 12 show electromagnetic simulation results for a case where the transmitting and receiving switch 200 is designed according to a semiconductor foundry process design kit (PDK) and a circuit layout based on a CMOS (Complementary Metal Oxide Semiconductor). The target frequency band of the transmitting and receiving switch 200 is a 28 GHz band.

FIG. 10 is a graph showing a simulation result of a frequency characteristic in a transmission mode operation of the transmitting and receiving switch 200 according to the exemplary embodiment of the present invention.

In FIG. 10, the insertion loss means insertion loss of a signal passing through the path from the transmitting front-end module 100 to the antenna 300. As shown in FIG. 10, the insertion loss is about 1.5 dB in the 28 GHz band. This insertion loss is an insertion loss considering an anti-static circuit and shows good performance in the 28 GHz frequency band.

Meanwhile, in FIG. 10, the input reflection coefficient refers to the reflection coefficient measured at the transmitting front-end module 100, and the output reflection coefficient refers to the reflection coefficient measured at the antenna 300.

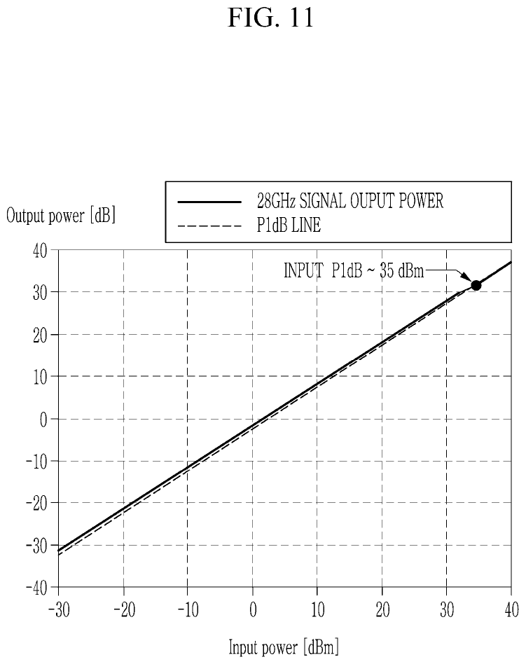

FIG. 11 is a graph showing results of a P1 dB simulation in the transmission mode operation of the transmitting and receiving switch 200 according to the exemplary embodiment of the present invention.

When the transmitting and receiving switch 200 according to the exemplary embodiment of the present invention operates in the transmission mode, the high output power is mostly applied to the passive elements. Accordingly, high output performance can be obtained. As shown in FIG. 11, it can be seen from the simulation result that the input P1 dB is about 34 dBm (˜2.5 W), and the high output signal can be driven.

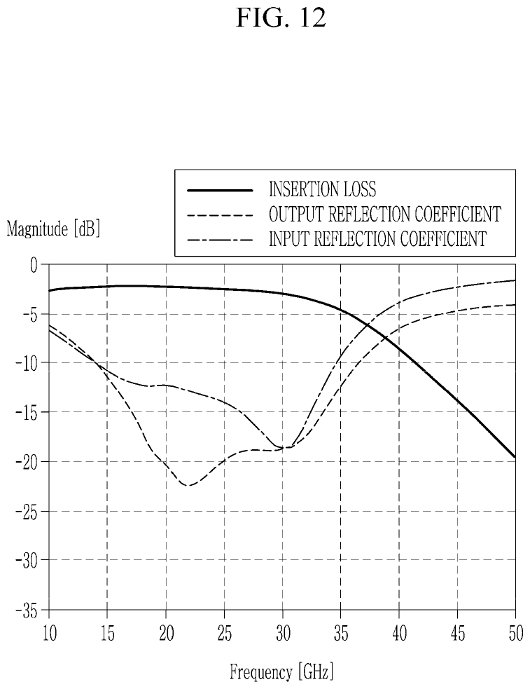

FIG. 12 is a graph showing a simulation result of a frequency characteristic in a reception mode operation of the transmitting and receiving switch 200 according to the exemplary embodiment of the present invention.

In FIG. 12, the insertion loss means insertion loss of a signal passing through the path from the antenna 300 to the receiving front-end module 400. As shown in FIG. 12, the insertion loss is about 2.7 dB in the 28 GHz band. This insertion loss is an insertion loss considering an anti-static circuit. Meanwhile, since the size of the parasitic capacitors of the switches becomes smaller as the process becomes finer, the insertion loss in the reception mode can be made smaller.

In FIG. 12, the input reflection coefficient refers to the reflection coefficient measured at the receiving front-end module 400, and the output reflection coefficient refers to the reflection coefficient measured at the antenna 300.

Since most of the high output signals are applied to both ends of the passive elements during the transmission mode operation, the transmitting and receiving switch 200 according to the exemplary embodiment of the present invention described above can provide a stable switching function even at a high transmission signal output. Thus, the transmitting and receiving switch 200 according to the exemplary embodiment of the present invention is applicable not only to a wireless communication device for a low-output terminal but also to a high-output outdoor wireless communication device.

Further, the transmitting and receiving switch 200 according to the exemplary embodiment of the present invention does not need an additional anti-static circuit because some of the internal matching circuits also operate as an anti-static circuit. Since no additional antistatic circuit is used in this manner, the size of the chip can be reduced. Since an additional insertion loss is not generated by an additional antistatic circuit, insertion loss performance can be improved. Impedance matching can be made easier since no additional matching components due to additional anti-static circuits are required. Since there is no additional frequency characteristic limitation due to an additional anti-static circuit, there is an advantage that a broadband transmitting and receiving switch can be realized.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A transmitting and receiving switch for transmitting a transmission signal received from a transmitting front-end module to an antenna and for transmitting a reception signal received from the antenna to a receiving front-end module, the transmitting and receiving switch comprising:
a first switch configured to be connected between the transmitting front-end module and the antenna;
a second switch configured to be connected between the receiving front-end module and a ground;
a first inductor configured to be connected between the second switch and the antenna;
a second inductor configured to be connected between the antenna and the ground; and
a variable capacitor configured to be connected between the antenna and the ground.

2. The transmitting and receiving switch of claim 1, wherein
when the transmitting and receiving switch operates in a transmission mode, the first switch and the second switch are turned on.

3. The transmitting and receiving switch of claim 2, wherein
when the transmitting and receiving switch operates in a reception mode, the first switch and the second switch are turned off.

4. The transmitting and receiving switch of claim 1, wherein
the variable capacitor is set to a higher capacitance value when the transmitting and receiving switch operates in a transmission mode than when the transmitting and receiving switch operates in a reception mode.

5. The transmitting and receiving switch of claim 1, wherein
the first inductor, the second inductor, and the variable capacitor perform an impedance matching function, and
the second inductor performs an anti-static circuit function together with the impedance matching function.

6. The transmitting and receiving switch of claim 5, wherein
static electricity applied to the antenna flows through the second inductor and the ground.

7. The transmitting and receiving switch of claim 1, wherein
the variable capacitor comprises:
a first capacitor configured to be connected between the antenna and the ground;
a second capacitor configured to have one end connected to the antenna; and
a third switch configured to be connected between the other end of the second capacitor and the ground.

8. The transmitting and receiving switch of claim 7, wherein
when the transmitting and receiving switch operates in a transmission mode, the third switch is turned on, and
when the transmitting and receiving switch operates in a reception mode, the third switch is turned off.

9. The transmitting and receiving switch of claim 1, wherein
each of the first switch and the second switch is a transistor,
a gate resistor is connected to a gate of each of the transistors, and
a body resistor is connected to a body terminal of each of the transistors.

10. The transmitting and receiving switch of claim 1, wherein
when the transmitting and receiving switch operates in a transmission mode, the transmission signal is applied to both ends of the first inductor.

11. A transmitting and receiving apparatus comprising:
an antenna;
a transmitting front-end module configured to output a transmission signal;
a receiving front-end module configured to receive a reception signal from the antenna,
a first switch configured to be connected between the antenna and the transmitting front-end module and turned on at the time of transmission of the transmission signal;
a second switch configured to be connected between the receiving front-end module and a ground and turned on at the time of transmission of the transmission signal;
a first inductor configured to be connected between the second switch and the antenna;
a second inductor configured to be connected between the antenna and the ground; and
a variable capacitor configured to be connected in parallel to the second inductor.

12. The transmitting and receiving apparatus of claim 11, wherein
the first switch and the second switch are turned off at the time of reception of the reception signal.

13. The transmitting and receiving apparatus of claim 11, wherein
the variable capacitor has a higher capacitance value at the time of reception of the reception signal than at the time of transmission of the transmission signal.

14. The transmitting and receiving apparatus of claim 11, wherein
the second inductor performs an anti-static circuit function together with an impedance matching function.

15. The transmitting and receiving apparatus of claim 14, wherein
when the second inductor performs the anti-static circuit function, static electricity applied to the antenna flows through the second inductor and the ground.

16. The transmitting and receiving apparatus of claim 11, wherein
the variable capacitor comprises:
a first capacitor configured to be connected between the antenna and the ground;
a second capacitor configured to have one end connected to the antenna; and
a third switch configured to be connected between the other end of the second capacitor and the ground.

17. The transmitting and receiving apparatus of claim 16, wherein
when the transmitting and receiving apparatus operates in a transmission mode, the third switch is turned on, and
when the transmitting and receiving apparatus operates in a reception mode, the third switch is turned off.

18. An operating method of a transmitting and receiving switch for transmitting a transmission signal received from a transmitting front-end module to an antenna and for transmitting a reception signal received from the antenna to a receiving front-end module, the operation method comprising:
transmitting a transmission signal to the antenna by turning on a first switch connected between the transmitting front-end module and the antenna and turning on a second switch connected between the receiving front-end module and the ground in a transmission mode; and
providing impedance matching by using a first inductor connected between the second switch and the antenna, a second inductor connected between the antenna and the ground, and a variable capacitor connected between the antenna and the ground in the transmission mode.

19. The operating method of claim 18, further comprising:
transmitting the reception signal to the receiving front-end module by turning off the first switch and the second switch in a reception mode; and
providing impedance matching by using the first inductor, the second inductor, and the variable capacitor.

20. The operating method of claim 18, wherein
the capacitance value of the variable capacitor is set to a higher value in the transmission mode than in the reception mode.
